(19) United States
(12) Patent Application Publication
(10) Pub. No.: US 2014/0190417 A1
(43) Pub. Date: Jul. 10, 2014

(54) Pet Bed

(71) Applicants: John M. Lipscomb, Cedarburg, WI (US); Michael A. Directo, San Diego, CA (US)

(72) Inventors: John M. Lipscomb, Cedarburg, WI (US); Michael A. Directo, San Diego, CA (US)

(73) Assignee: PIONEER PET PRODUCTS, LLC, Cedarburg, WI (US)

(21) Appl. No.: 13/985,873

(22) PCT Filed: Feb. 15, 2012
(86) PCT No.: PCT/US12/25325

§ 371 Date: Dec. 20, 2013

Related U.S. Application Data
(60) Provisional application No. 61/443,231, filed on Feb. 15, 2011.

(51) Int. Cl. A01K 1/035

(52) U.S. Cl. CPC A01K 1/0353
USPC 119/28.5

(57) ABSTRACT

A pet bed having a cushion that includes multiple pillows that can be removed and washed is disclosed. The pet bed has a cover with multiple pockets, each of which holds one or more of the pillows while allowing the pillows to be removed from and replaced into the respective pocket which permits selective washing of individual segments of the cushion. The bed is formed of a cover having a plurality of pairs of radially and upwardly extending bolster cushion pillow receiving pockets that each receive a bolster cushion and a center cushion pocket locking the bolster cushion pillows in their respective pockets when a center cushion pillow is received in the center cushion pocket and a covering flap of the cover closed.

### FIELD

The present invention relates generally to pet beds and, particularly, toward a pet bed of more durable and washable construction.

### BACKGROUND

There are countless pet beds on the market, many of which have enjoyed considerable commercial success. Such beds are typically made of an outer fabric cover or duvet that is sewn in a manner that imparts a desired bed shape that is filled internally with a fill, such as a cotton or polyester fiber filling. Unfortunately, despite many of these beds starting out providing a relatively comfortable bedding surface for a pet, problems remain. As a cat or dog continues to use their bed, it is common for the filling within the cover to become displaced, bunch up, or become lumpy adversely affecting comfort. With continued use, filling will actually work its way completely through the cover causing the bed to undesirably “shed” filling. In addition, some cats and dogs will bite, tear or paw their bed which can increase wear and tear, reducing useful bed life.

What is needed is an improved pet bed that is not only washable but more durable while remaining comfortable.

### SUMMARY

The present invention is directed to a washable pet bed formed of a cover with a plurality of cushion defining pockets in which a cushion that can be a pillow filled with foam or fiber fill is received. In a preferred pet bed, the cover is sewed with seams defining a plurality of pairs of pockets each receiving a cushion that is a pillow with one of the pillows engaging another one of the pillows in a manner that helps impart cushioning support to the pet bed. Such a bed construction advantageously allows components of the bed, namely its cushions, e.g., pillows, to be removed from the cover enabling both the cushions and the cover to be machine washed.

In one preferred pet bed, the cover is formed so it includes a plurality of pairs of radially outwardly extending seams that help define a cushion insertion or removal opening in its underside or base. The seams sewed into the cover also define a plurality of pairs if circumferentially spaced apart, radially outwardly extending, and generally upwardly extending bolster cushion pockets in which bolster cushions which each can be pillows. The cushion insertion or removal opening communicates with a center cushion defining pocket that permits insertion of a generally round or circular center cushion that is a pillow larger than a plurality of the bolster cushions or bolster pillows helping to support the bolster cushions or pillows and lock them in place.

In one preferred bed embodiment, the bed is generally circular having an upwardly extending bolster encircling a center cushion that can be of hemispherical construction with a plurality of bolster defining pockets each receiving a plurality of bolster cushion pillows received therein and a generally circular center cushion pillow disposed in a pocket underlying the bolster defining pockets in contact with ends of the bolster cushion pillows. The cover can be formed of two pieces of circular fabric joined by seams with a plurality of the seams defining a plurality of the bolster defining pockets and being spaced from a zippered covering flap permitting insertion and removal of the pillows.

One or both pieces of fabric, e.g., upper and lower fabric pieces, is made of a low friction material along with the outer pillow cover or cases that eases insertion of the pillows into their respective pockets while also minimizing friction between each pillow and a contacting part of the cover during animal interaction with the bed. Using pillows formed of a filling disposed within a pillow case or cover within a separate cover forming pockets within the bed that each pillow is received helps produce a more durable pet bed that prevents shedding of filling through the pillow cover and bed cover. A top outer portion of the bed cover is formed of a fleece to increase durability and reduce shedding as well as pillow wear and tear during animal interaction with the pet bed.

### DRAWING DESCRIPTION

One or more preferred exemplary embodiments of the invention are illustrated in the accompanying drawings in which like reference numerals represent like parts throughout and in which:

FIG. 1 is a top perspective view of a flat pet bed;

FIG. 2 is a top perspective view of another mattress-type pet bed;

FIG. 3 is a top perspective view of another preferred pet bed embodiment similar to the pet bed of FIG. 2;

FIG. 4 is a top perspective view of yet another pet bed that is a nest-type bed;

FIG. 5 is a top perspective view of a variant of the pet bed of FIG. 3;

FIG. 6 is a top plan view of the pet bed of FIG. 5 in a folded position;

FIG. 7 is a front elevation view of a round or oblong nest-type pet bed with a cat laying in it;

FIG. 8 is a top perspective view of a variant of the pet bed of FIG. 7;

FIG. 9 is a top perspective view of the bed of FIG. 7;

FIG. 10 is a bottom perspective view of the bed of FIG. 7;

FIG. 11 is a top, front perspective view of a donut-type pet bed;

FIG. 12 is a top plan view of the pet bed of FIG. 11;

FIG. 13 is a top plan view of the pet bed of FIG. 11 depicting in phantom pockets formed within the cover and removable pillows inserted into the pockets to form the pet bed;

FIG. 14 is a cross-section of the pet bed of FIG. 11 taken along line 14-14 of FIG. 13;

FIG. 15 is a bottom plan view of the pet bed of FIG. 11 depicting in phantom pockets formed within the cover and removable pillows inserted into the pockets to form the pet bed;

FIG. 16 is a bottom perspective view of the pet bed of FIG. 11;

FIG. 17 is a bottom perspective view of the pet bed of FIG. 11 illustrating removal of a bottom pillow;

FIG. 18 is a bottom perspective view of the pet bed of FIG. 11 after removal of the bottom pillow;

FIG. 19 is a bottom perspective view of the pet bed of FIG. 11 after removal of the bottom pillow showing the bottom pillow next to the rest of the pet bed;

FIG. 20 is an enlarged fragmentary perspective view of a portion of the interior of the pet bed cover depicting pockets formed in the cover holding a plurality of side pillows; and

FIG. 21 is an exploded perspective view of the pet bed of FIG. 11 with all pillows removed from the cover.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

FIGS. 1-4 illustrate pet beds 10, each having a cover 20 and a cushion 50 that includes multiple pillows 100. Each pet bed 10 is configured so that the pillows 100 can be individually removed from the remainder of the cushion 50, allowing (i) selective cleaning or replacement of portions of the cushion 50. This configuration also allows for cleaning of the entire cushion 50 by separating it into its pillow 100 constituents and simultaneously cleaning the pillows 100 together, in a manner that is compatible with typical household laundry washing and drying machines.

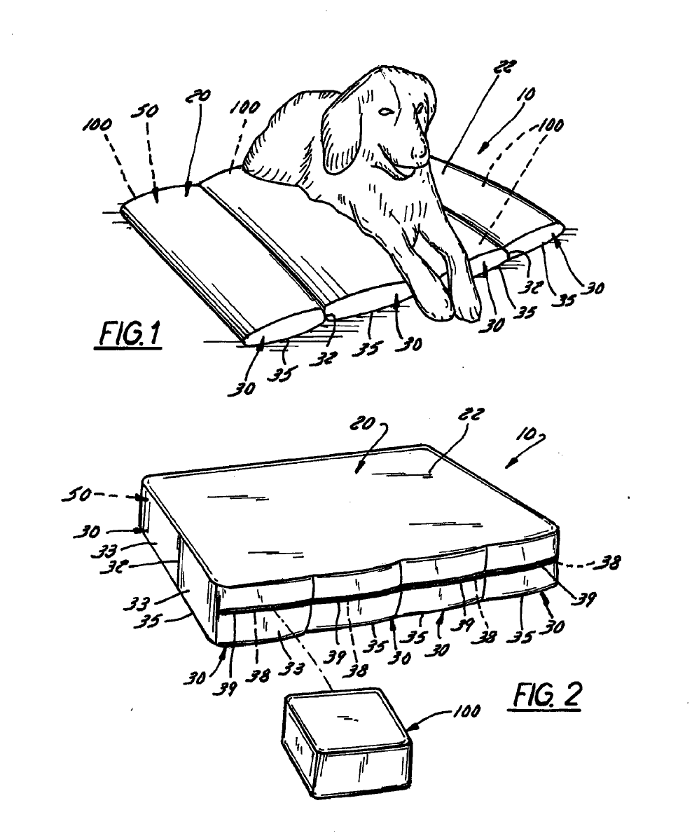

Cover 20 is preferably made from a material that can be cleaned using typical household laundry washing and drying machines. The cover 20 includes a top panel 22 that provides the surface upon which a pet can lie. In the embodiment illustrated in FIG. 2, the top panel 22 is made from a different material than the remainder of the cover 22. This top panel 22 is made from carpeting whereas the rest of the cover 20 is made from a fabric. In one embodiment, the entire cover 20, including the top panel 22, is made from a fabric, preferably a fabric that can be cleaned with typical household laundry washing and drying machines.

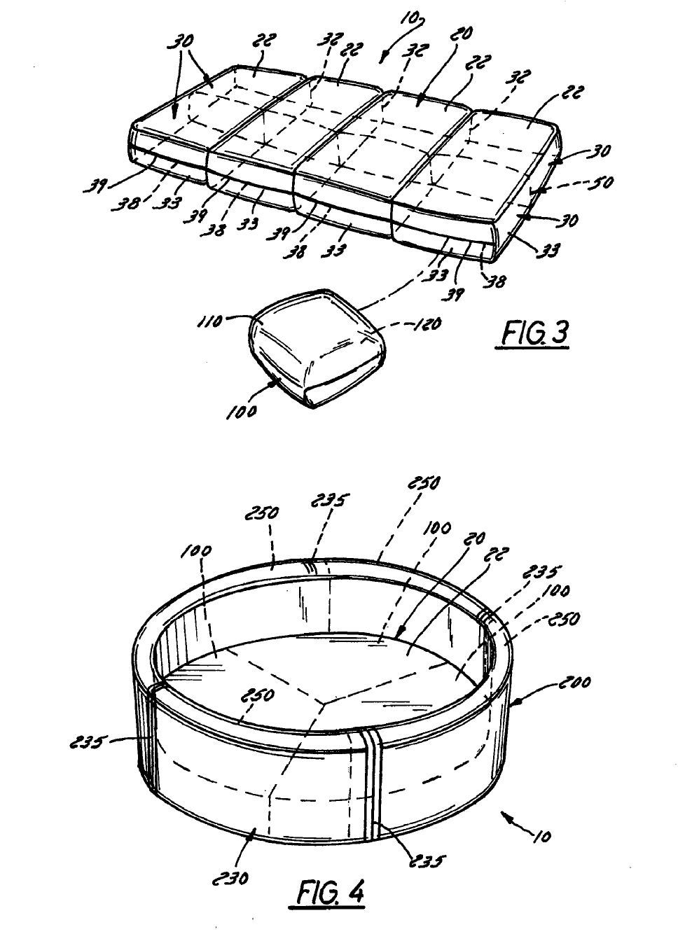

Pockets 30 extend downwardly from a lower surface of the top panel 22 toward the bottom of the pet bed 10. Adjacent pockets 30 share a common divider wall 32 between them. Referring now to FIGS. 2 and 3, in these embodiments, the pockets 30 include interconnected sidewalls 33 that extend downwardly from a lower surface of the top panel 22 toward the bottom of the pet bed 10. The pockets 30 have bottom wall(s) 35 that define the bottom of pet bed 10. In another embodiment, a bottom panel extends across and connects the pocket bottom wall(s) 35 or bottom edges of the pocket divider walls 32 to each other.

Referring to FIG. 3, pockets 30 of this embodiment are shaped and sized analogously to the pillows 100. In this configuration, a single pillow 100 is held in each of the pockets 30. In another embodiment, the pockets 30 are larger than each pillow 100 and sized to hold multiple pillows 100 in each pocket 30. For example, pocket 30 may be an elongate tube (FIG. 1) that accepts multiple aligned pillows 100 in it or an elongate pillow 100, depending on the particular configuration of the pillow(s) 100. Regardless of the particular configuration of the pockets 30, each pocket has an opening 38 that permits access into its void-like interior. The openings 38 allow the pillows 100 to be removable from and replaceable into the respective pockets 30. Openings 38 extend through outwardly facing sidewalls 33. In one embodiment, the openings 38 extend through the pocket bottom walls 35.

Referring now to FIGS. 2 and 3, in these embodiments, the openings 38 include cooperating zippers 39 that are attached to the sidewalls 33 and can hold the openings 38 closed. In one embodiment, the openings 38 are merely open slots, without a zipper 39 or other closure device. In another embodiment, the openings 38 include a flap that extends across the opening. In such embodiment, the flap can be secured against part of the pocket 30 to close the openings 38 with a button, hook and loop fasteners, zipper, or other suitable closure device(s).

Referring now to FIG. 2, the pillow 100 is made entirely from a cushioning material. A foamed polymeric material forms a unitary pillow 100 in this embodiment. Referring now to FIG. 3, this pillow 100 includes a pillow cover 110 that encloses cushioning material 120. The pillow cover 110 can be made from the same material as cover 20, or a different machine washable material(s).

Referring again to FIGS. 2 and 3, within the cushion 50, the pillows 100 are aligned in (i) multiple rows along a width of the bed 10 and (ii) multiple columns along a length of the bed 10. The pillows 100 collectively occupy at least about 95% of the overall footprint defined by the perimeter of the cushion 50. In another embodiment, the pillows 100 occupy relatively less space of the cushion 50 footprint, for example, at least about 80% or at least about 75%.

Pillows 100 preferably have a common perimeter shape which allows for their interchangeability with each other. As illustrated in FIGS. 2 and 3, the pillows 100 of these embodiments have substantially square perimeter shapes. As illustrated in FIG. 4, in this embodiment, the pillows 100 have substantially triangular perimeter shapes. In one embodiment, the pillows 100 have substantially rectangular perimeter shapes. In another embodiment, pillows 100 have substantially round perimeter shapes.

Regardless of the particular perimeter shape of the pillows 100, they are sized so that their overall dimensions and their overall masses accommodate their being cleaned in typical household laundry washing and drying machines. In other words, pillows 100 are small enough to be readily handled, absorb enough water to be thoroughly cleaned during a washing cycle, and release enough water during a drying cycle to be thoroughly dried. In one embodiment, the pillows 100 have length and width, or radius, dimensions that are less than about 10 inches. In another embodiment, the pillows 100 have length and width, or radius, dimensions that are less than about 18 inches.

In one embodiment, the pillows 100 are blocks made of a resilient and durable material that is machine washable. An example of one such material is an open cell or closed cell foam that is deformable. In one embodiment, each block 100 has a plurality of layers each having a firmness or compliance different than the other layer. In one preferred embodiment, the topmost layer of the block 100 that underlies the top surface of the top panel 22 of the cover 20 is more compliant or softer than a second layer of the block 100 that is disposed toward the bottom of the bed when the blocks 100 are all inserted into the cover 20.

In another embodiment, a plurality of layers of blocks 100 are employed with one layer of blocks 100 having a firmness or compliance different than another layer of blocks 100 having different layered blocks stacked on top of each other when inserted into the bed cover 20. In one preferred embodiment, the cover 20 has an internal separator or divider panel that permits easy insertion of the different layers of blocks. In one embodiment, the separator or divider is configured to provide individual block-receiving and retaining pockets that receive each block of one block layer and orient it so it overlies another block of another block layer. In another embodiment, a tubular arrangement, such as a series of tubes, e.g., arranged in parallel and/or in layers, can be disposed within the cover 20 with each tube configured to accept at least one of the blocks. In one embodiment, the tubular arrangement orients blocks inserted into tubes of the tubular arrangement so they are on top of one another defining separate block layers that collectively serve as a mattress cushion for the pet bed.

Referring now to FIGS. 4, in this embodiment, the pet beds 10 includes a bolster 200 that extends along the perimeter of the cushion 50 and extends upwardly beyond the cushion 50. The bolster 200 includes bolster pockets 230 that have openings 235 which permit access into and out of the bolster pockets 230. A bolster pillow 250 is held in each of the bolster pockets 230. Bolster pillows 250, like pillows 100, are configured to be cleaned with typical household laundry washing and drying machines.

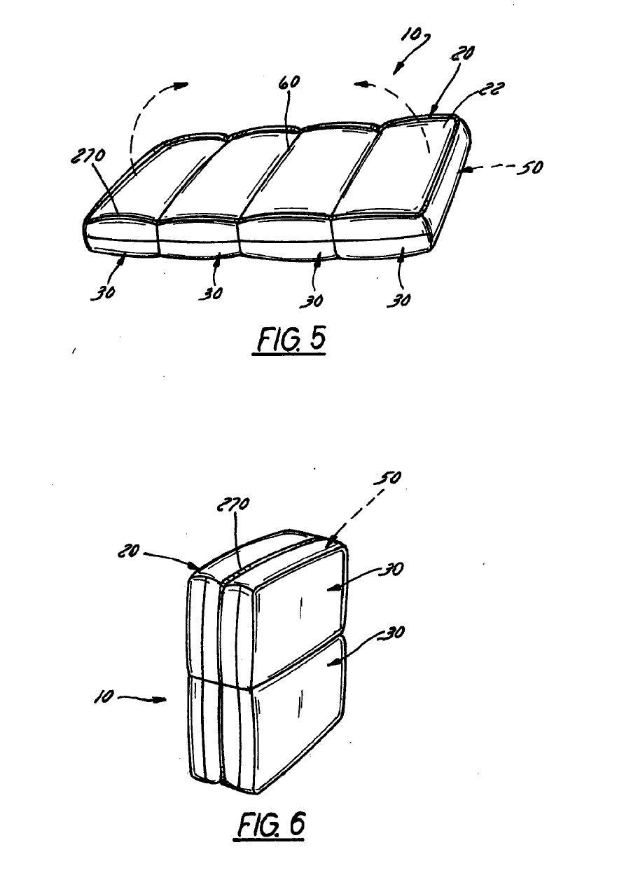

Referring now to FIGS. 5 and 6, the cushion 50 may define a fold line 60. Along this fold line 60, the cushion 50 can be folded to bring opposing ends of the cushion 50 toward each other to facilitate movement and/or storage of the pet bed. The fold line 60 is preferably provided between adjacent pockets 30 that do not share a common sidewall.

Stated another way, in these embodiments, instead of a common divider wall 32 between adjacent pockets 30, each of the adjacent pockets 30 has its own divider wall 32. In this configuration, the divider walls 32 of the adjacent pockets 30 face and abut each other, while allowing the adjacent pockets 30 to transversely flex away from each other. This allows the respective sidewalls of the adjacent pockets 30 to flex away from each other, pivoting substantially about the fold line 60 and through the portion of the cover 20 that connects the adjacent pockets 30. Thus, divider walls 32 of the adjacent pockets 30 that faced each other when the cushion 50 is unfolded and lying flat on a supporting surface will be substantially coplanar when the cushion 50 is fully folded, so that they define a common exposed surface of the folded pet bed 10.

The embodiment of FIGS. 5 and 6 has a zipper 270 that extends along an upper edge of the pet bed 10 when the cushion 50 is unfolded and lying flat on a supporting surface (FIG. 5). When the cushion 50 is fully folded (FIG. 6), the zipper 270 extends along three sides of the folded pet bed 10 so that the pet bed 10 is fully enclosed and held in this folded position with the top panel 22 of the cover 20 being folded in half, against itself. In another embodiment, the zipper 270 extends along at least portions of only two, optionally one, of the sides of the folded pet bed 10. In yet another embodiment, zipper 270 is not employed but instead a different closure device is used. Examples of other suitable closure devices include buttons, hook and loop fasteners, and ties. Regardless of the particular type of closure used to hold the pet bed 10 in its folded position, it is able to hold the pet bed 10 in such folded position in a manner that is suitable for storage and to facilitate movement of the pet bed 10 for use outdoors, in an automobile, or otherwise.

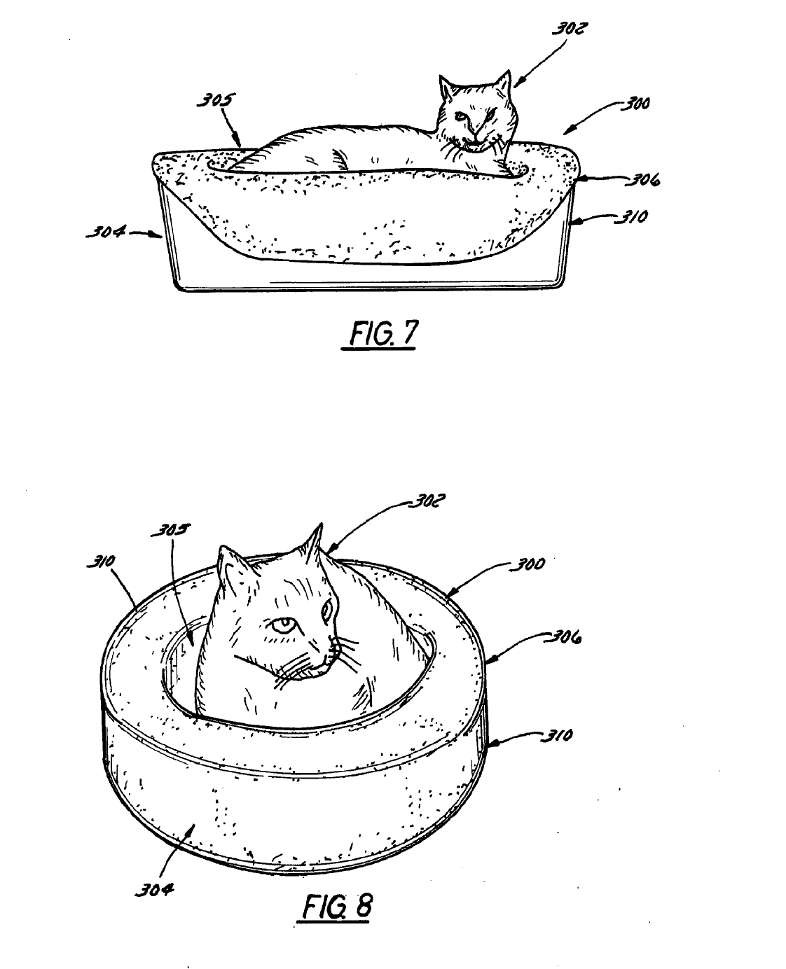

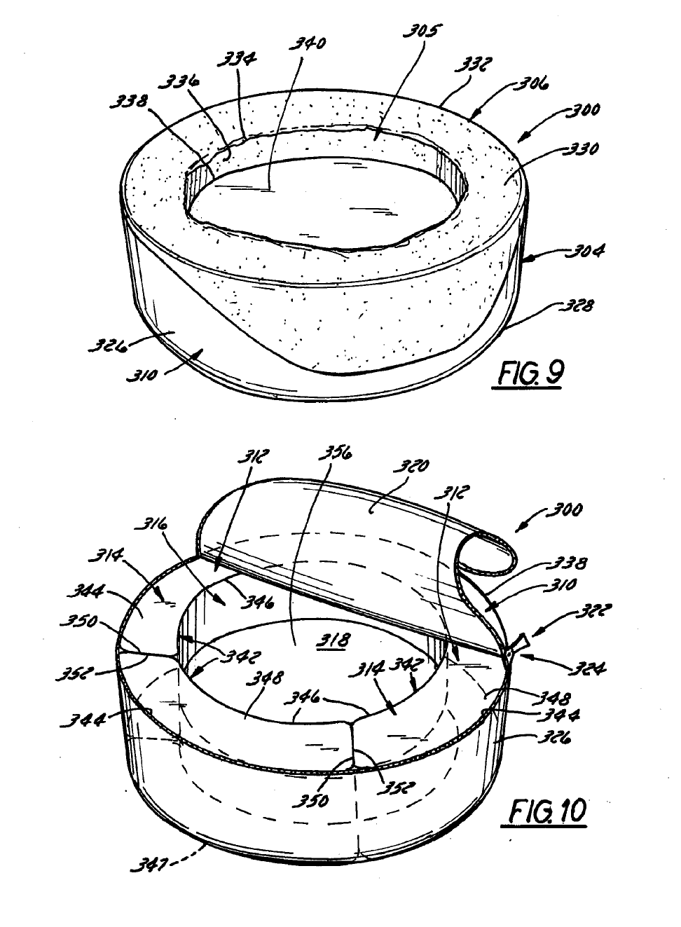

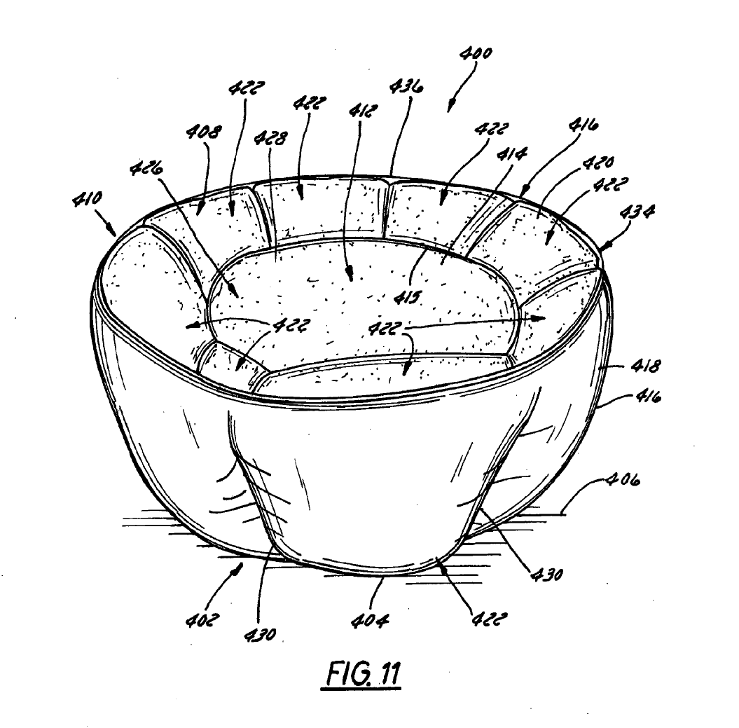

FIGS. 7-10 illustrate a round pet bed 300 that can be oblong, e.g., oval, or round, which is well suited for a pet 302, such as a cat or dog. Pet bed 300 can be a donut-type or shaped pet bed. The bed 300 has a base 304 from which a sidewall 306 upwardly extends providing a rim or upstanding edge that encompasses a mattress 308 (FIG. 9) upon which the pet 302 can lie defining a recessed nest 305 that is comforting to the pet 302. As is best shown in FIG. 10, the bed 300 includes a complementarily configured cover 310 formed with an annular channel 312 in which an annular sidewall cushion arrangement 314 is received. The sidewall cushion arrangement 314 defines an interior recess 316 in which a mattress cushion arrangement 318 is received. The cover 310 has a bottom panel 320 of reclosable construction that can be opened using a closure 322, such as a zipper 324, to allow removal and washing of the cushion arrangements 314 and 318 and closed, to retain the cushion arrangements 314 and 318. When the cushion arrangements 314 and 318 are assembled within the cover 310 and the zipper 324 closed, the cover 310 cooperates with the cushion arrangements 314 and 318 to hold them in place, structurally support the cushion arrangements 314 and 318, and give form to the pet bed 300.

With specific reference to FIGS. 9 and 10, the cover 310 has a sidewall panel 326 that is joined to the bottom panel 320 by a seam 328 that at least partially is formed by the zipper 324. The cover 310 includes a top panel 330 joined by a top outer corner or top outer seam 332 to the sidewall panel 326 and joined by another top inner corner or top inner seam 334 to an interior sidewall panel 336 that encircles the mattress 308. The interior sidewall panel 336 is joined by a bottom inner corner or bottom inner seam 338 to a mattress panel 340 that overlies the mattress cushion arrangement 318.

The cover sidewall panel 326, top panel 330, and interior sidewall panel 336 define the sidewall cushion seating channel or pocket 312 in which the sidewall cushion arrangement 314 is inserted during assembly of the bed 300. The mattress cushion arrangement 318 is then inserted into the mattress cushion seating recess 316 until it bears against an interior surface of the mattress panel 340 of the cover 310. The zipper 324 is then zipped up to close the cover 310 by attaching the bottom panel 320 to the sidewall panel 326. Cooperation between the panels 320, 326, 330, 336 and 340 and cushion arrangements 314 and 318 when the zipper 324 is closed causes the cover 310 to support the cushion arrangements 314 and 318 and give the desired form to the pet bed 300.

To help facilitate cleaning of the pet bed 300, the sidewall and mattress cushion arrangements 314 and 318 are made of a durable, resilient and washable material, such as an open or closed cell foam or the like, which can be conveniently removed from the cover 310 and washed in a washer, such as a home washing machine of conventional construction. Cover 310 is also made of a durable and resilient material that is also machine washable that enables the cover 310 to be washed in a washing machine separately or together with the cushion arrangements 314 and 318.

With reference to FIG. 10, the sidewall cushion arrangement 314 is made of a plurality of cushion blocks 342 that enable the sidewall cushion arrangement 314 to be disassembled into even smaller pieces that are even easier and more convenient to wash. Each block 342 made of a durable, resilient and washable material that can also be deformable and possess sufficient compliance so as to cushion a pet 302 in the bed 300 while also providing support to the pet 302. In one embodiment, each cushion block 342 is made of open or closed cell foam but can be made of another machine washable material possessing suitable durability, resilience and/or compliance. Each cushion block 342 has a pair of outer and inner sidewalls 344 and 346, top and bottom walls 347 and 348, and end walls 350 and 352 and is configured to define an annular cushion arrangement when the blocks 342 are placed end-to-end in the sidewall-cushion seating channel or pocket 312 in the cover 310. In the embodiment shown in FIG. 10, the sidewall cushion arrangement 314 is made of a plurality of pairs of blocks 342, namely four blocks 342, arranged end-to-end.

Each block 342 has an outer sidewall 344 that is curved so as to define a bed sidewall 306 that is circular where the pet bed 300 is round. Blocks 342 can have a different outer sidewall shape or shapes depending on the shape of the pet bed. In the preferred embodiment shown, the block sidewalls 344 and 346 are both curved and can be generally equidistantly spaced apart such as to produce sidewalls 344 and 346 that are generally parallel. When assembled end-to-end, such as in the manner depicted in FIG. 10, the blocks 342 define a circular or generally cylindrical mattress cushion receiving recess 316 that guides or locates a mattress cushion arrangement 318 that is disk-shaped or generally cylindrical in shape.

While the channel or pocket 312 can be uninterrupted, the seat cover 310 can be formed with interior radially extending panels (not shown) that divide the channel or pocket 312 into smaller pockets each configured to receive and releasably retain one of the blocks 342 therein. Such a cover 310 can also include an inner block retaining wall that also serves to define at least part of the mattress cushion arrangement receiving recess 316.

In one preferred embodiment, the mattress cushion arrangement 318 is formed of a single disk-shaped or generally cylindrical mattress cushion 356 that is also made of a suitably durable and resilient material that is also machine washable. In another embodiment, the mattress cushion arrangement 318 can be formed of a plurality of disk-shaped or cylindrical cushions placed one on top of the other. Where multiple mattress cushions are used, the mattress cushion underlying the mattress cover panel 340 is formed to have a different amount of compliance than another mattress cushion. For example, in one embodiment, an upper mattress cushion is constructed to be more compliant or softer than a mattress cushion underlying the upper cushion. Where the mattress cushion arrangement 318 is formed of multiple cushions, the cover 310 can be formed with individual pockets or tubes into which each mattress cushion is inserted in assembling the pet bed.

The sidewall cushion arrangement 314 can also be constructed to have a firmness or compliance different than that of the mattress cushion arrangement 318. For example, in one preferred embodiment, at least those portions of the sidewall cushion blocks 342 that are received in the pocket or channel 312 in the cover 310 have a compliance or stiffness greater than that of the mattress cushion arrangement 318 (or at least greater than the topmost mattress cushion or cushion layer). In another embodiment, different cushion blocks 342 can have different compliances or firmness such as along a portion of the pet bed sidewall that is intended to serve as an entrance to the bed 300.

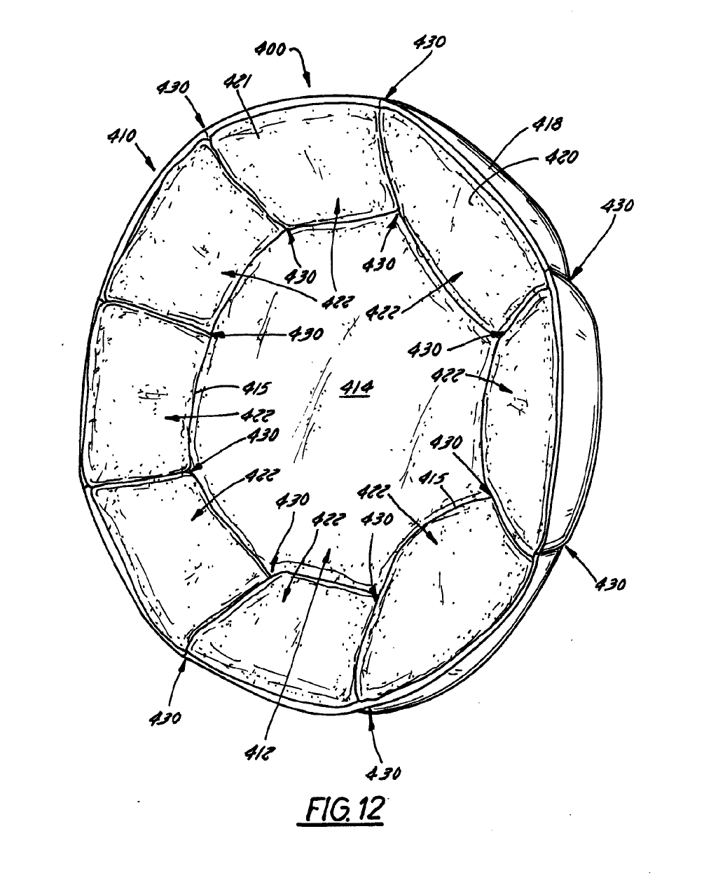

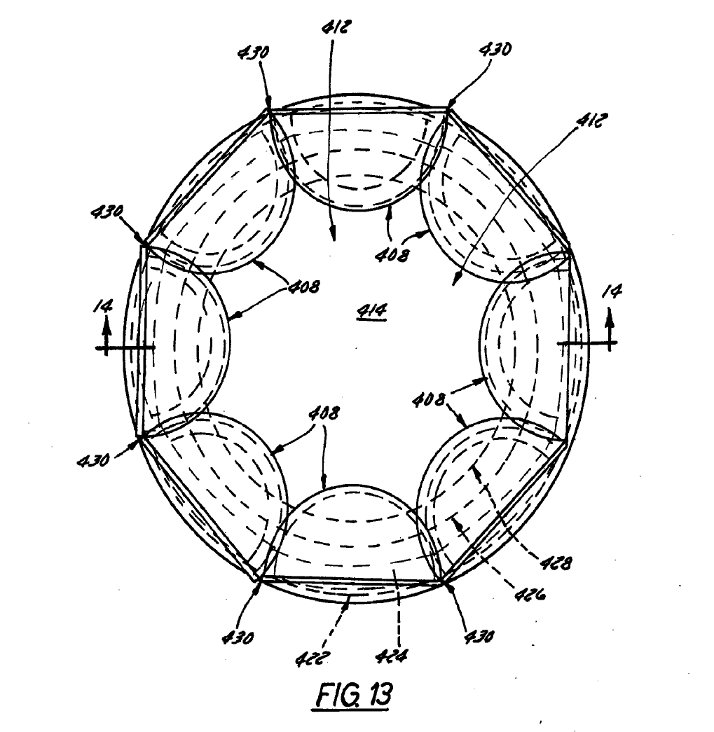

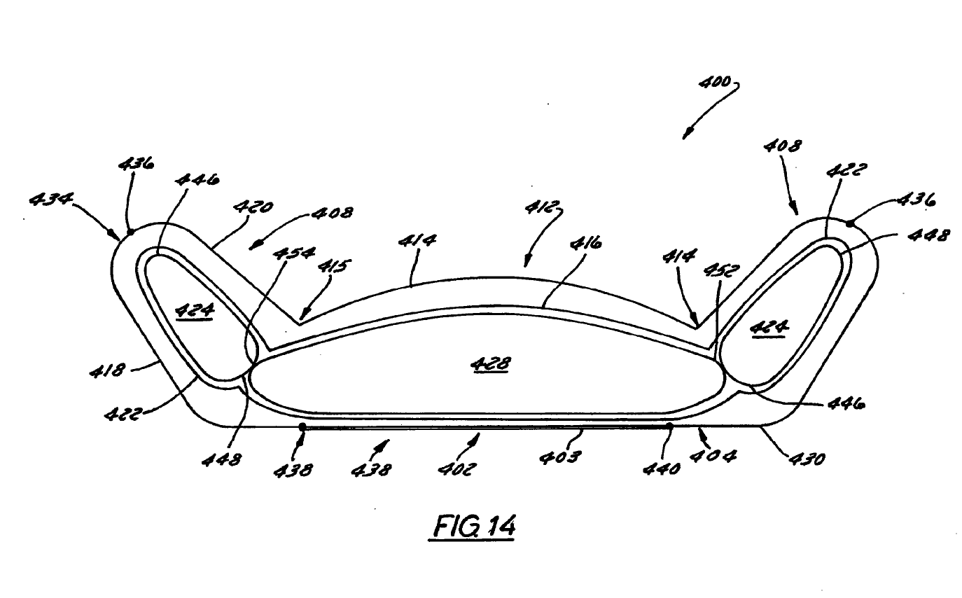

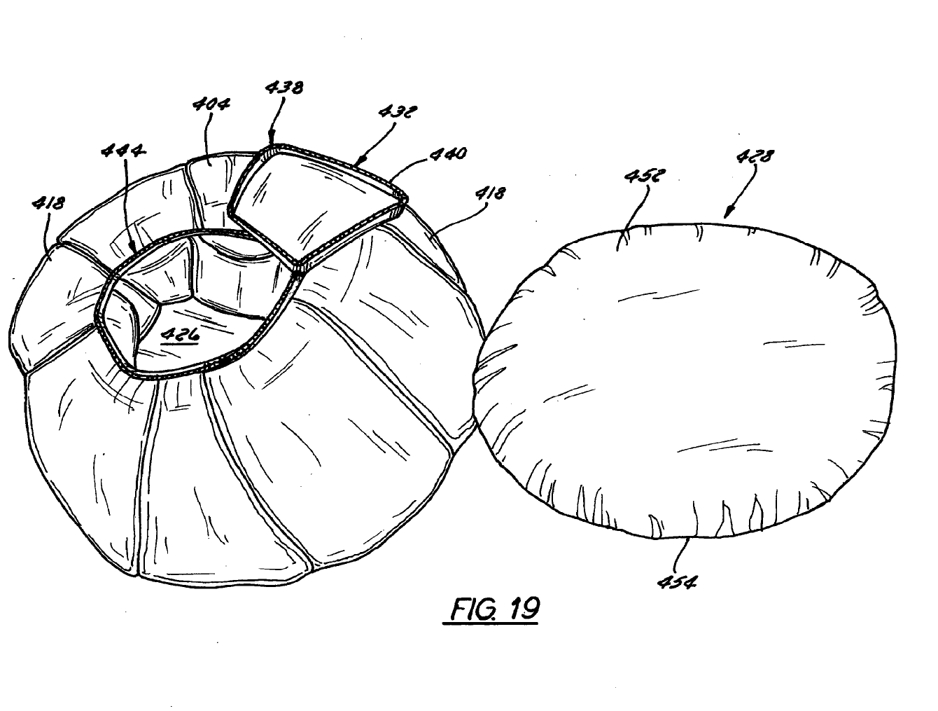

FIGS. 11-21 illustrate another preferred pet bed assembly 400 constructed in accordance with the present invention that is a donut-type pet bed 400 having a base 402 providing a bottom surface 404 upon which the bed 400 can rest upon the floor 406 or other generally flat surface. Extending upwardly relative to the base 402 is a bolster 408 of generally toroidal construction that defines an outer pet bed sidewall 410 that surrounds an inner center cushion 412 having a generally hemispherical outer center cushion surface 414 upon which a pet, such as a cat or dog, can lay. As is best shown in FIGS. 11 and 12, the outer margin 415 of the center cushion 412 is generally round.

The pet bed 400 is formed of an outer cover 416 made of a generally circular bottom piece of fabric 418 that is attached to a generally circular top piece of fabric 420 in a manner that defines a plurality of pairs, i.e., at least three, bolster cushion defining pockets 422 in which generally rectangular bolster pillows 424 are each received and a center cushion defining pocket 426 that holds a generally round center cushion pillow 428. With continued reference to FIGS. 11-21, the bottom piece of fabric 418 is attached to the top piece of fabric 420 by a plurality of pairs, i.e., at least three, of circumferentially spaced apart generally radially outwardly extending elongate seams 430 with the spacing between adjacent seams 430 defining bolster cushion pockets 422. Each seam 430 extends from a pillow covering flap 432 formed in the bottom piece of fabric 418 adjacent or to a top surface 434 or outer edge 436 of the bed 400 joining the two fabric pieces 418 and 420 together while also helping to define the center cushion pocket 426.

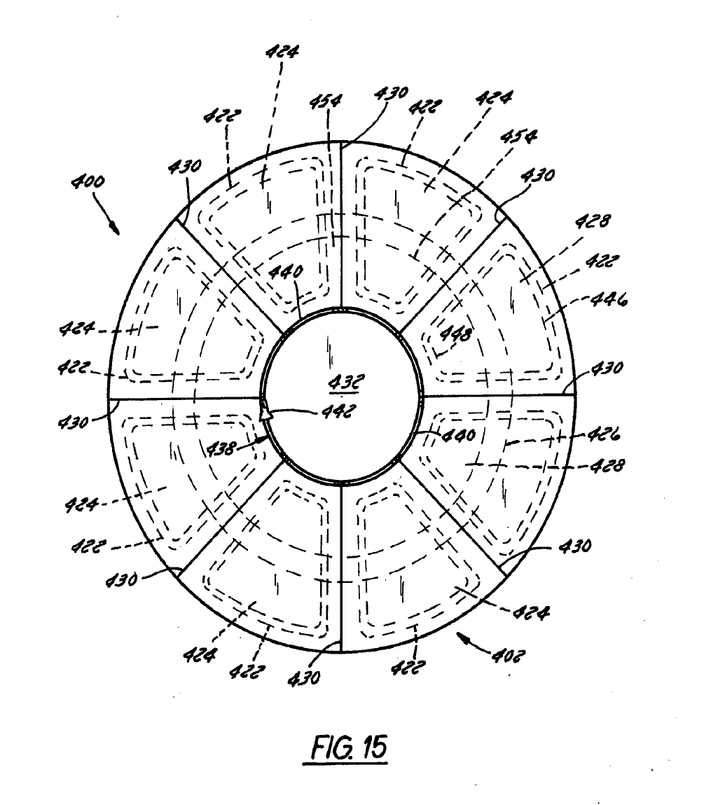

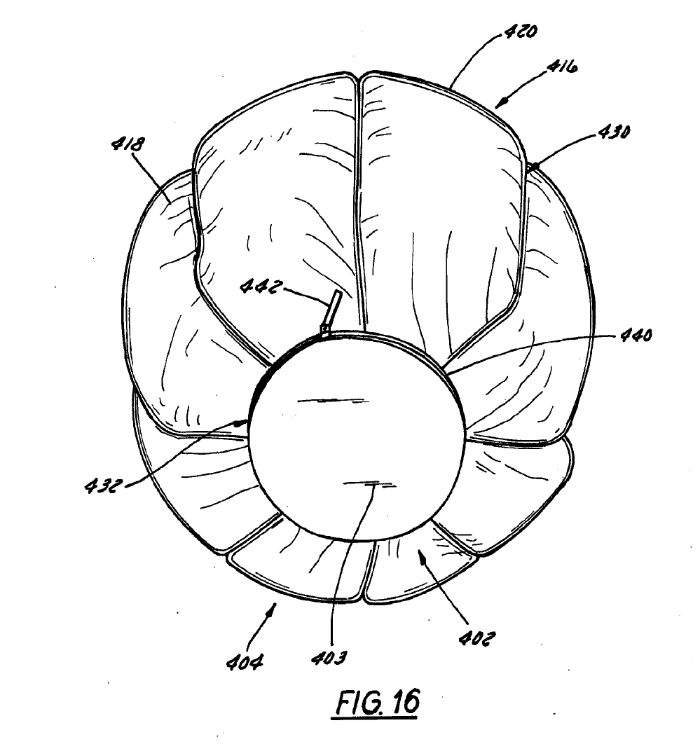

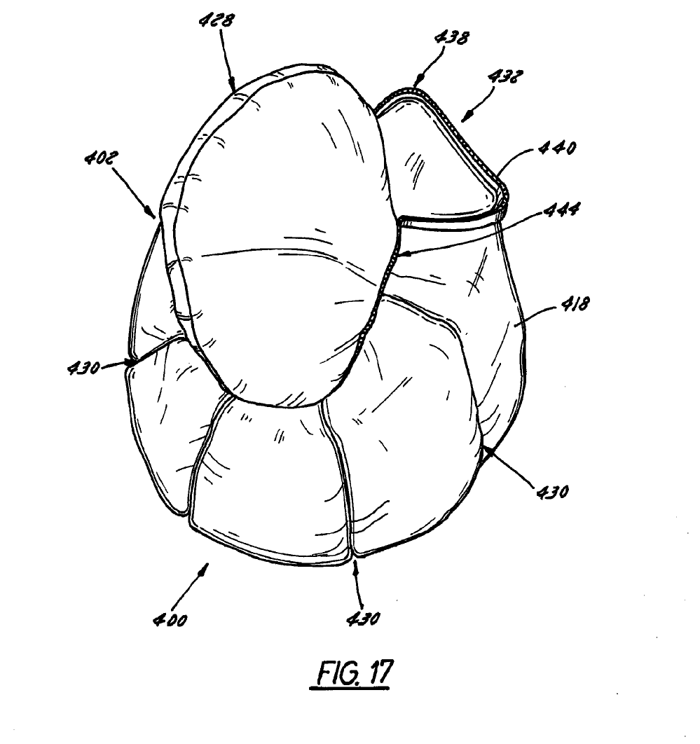

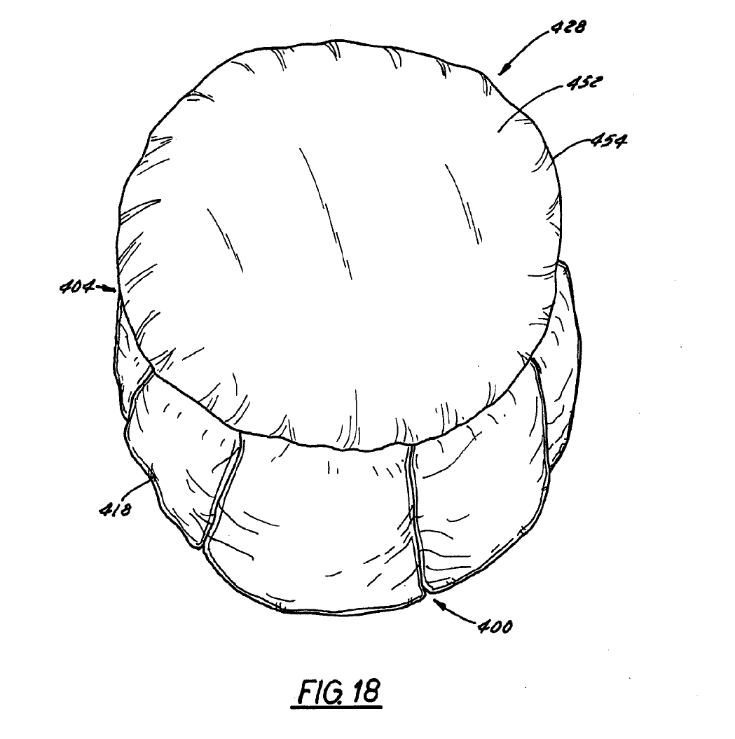

The pillow covering flap 432 is generally round and is releasably attached about its periphery to a surrounding portion of the bottom fabric piece by a closure arrangement 438 formed by an elongate generally circular zipper 440 that is manually pulled via a zipper pull 442 between a closed position, such as shown in FIG. 16, and an open position, such as shown in FIG. 17, allowing removal of center cushion pillow 428 before removal of bolster pillows 424. As is best shown in FIG. 15, the pillow covering flap 432 is circular and smaller in diameter than the diameter of the center cushion pillow 428 when the pillow 428 is received in the center cushion pillow pocket 426.

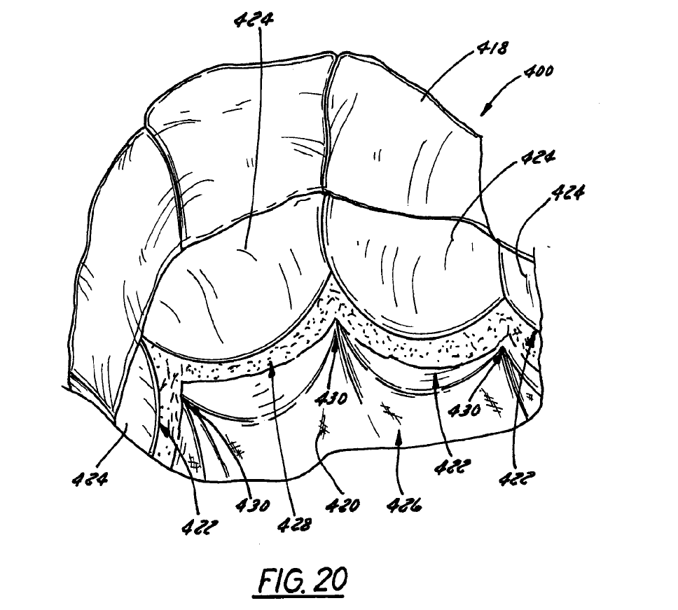

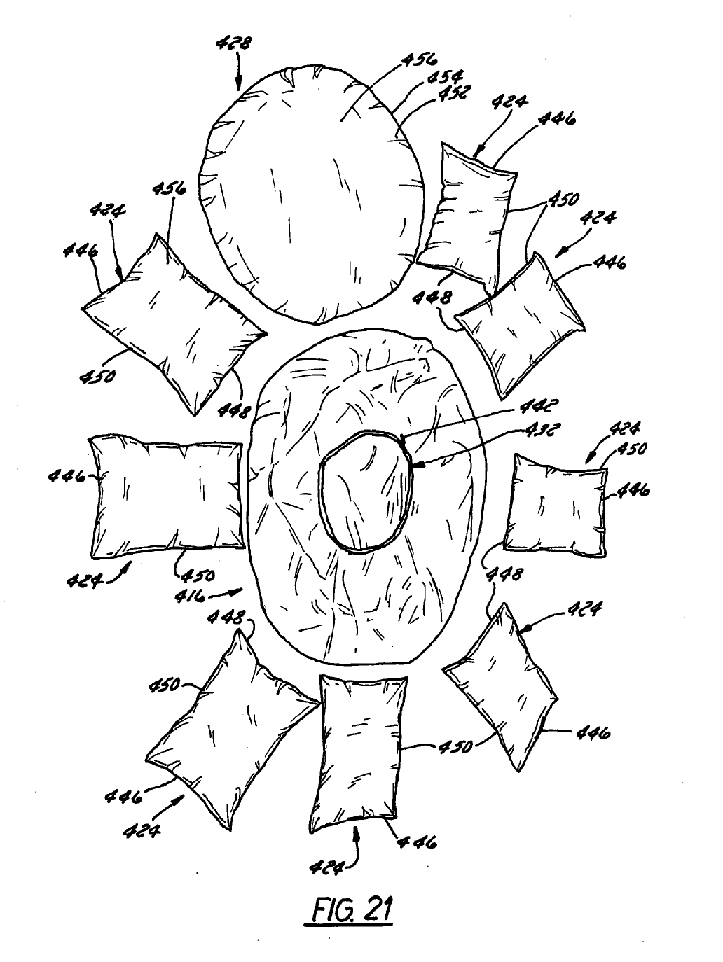

When the pillow covering flap 432 is unzipped and pulled away so it is opened, it exposes a pillow insertion and removal opening 444 that permits removal of the center cushion pillow 428 from its pocket 426 in the cover 416, such as depicted in FIGS. 17-19. With additional reference to FIGS. 20 and 21, once the center cushion pillow 428 is removed, each one of the bolster pillows 424 are removed from its respective bolster cushion defining pocket 422 allowing each pillow 428 and 424 to be conveniently and easily washed in a conventional machine washer along with the empty cover 416.

In assembly of the pet bed 400, each elongate bolster cushion pillow 424 is manually grasped and inserted through the opening 444 in the cover 416 into a respective one of the pockets 422 with one end 446 or 448 of the pillow 424 disposed against or adjacent bolster top 434. When each bolster cushion pillow 424 is inserted into its corresponding pocket 422 formed in the cover 416, the opposite end 448 or 446 of each elongate pillow 424 is disposed facing toward and can be at least partially received in the center cushion pillow pocket 426, such as depicted in FIG. 20. Each bolster cushion pillow 424 is a quadrilateral that preferably is of an isosceles trapezoidal shape or generally rectangular like that shown in FIG. 21 having a sidewall 450 disposed between its ends 446 and 448.

When each bolster cushion pillow 424 is inserted into its respective pocket 422, it provides form and shape to the corresponding portion of the bolster 408 adjacent the pillow 424. Thereafter, the round center cushion pillow 428 is inserted through the opening 444 in the bottom 402 of the cover 416 into the center cushion pocket 426. The center cushion pillow 428 is generally circular having an outer margin 452 encircling its outer periphery 454 abutting an adjacent end 446 or 448 of each bolster cushion pillow 424. As is best shown in FIG. 15, once the center cushion pillow 428 is inserted into its pocket 426 and the cover flap 432 zipped up, the outer margin 454 of the pillow 428 abuts and overlaps a corresponding end 446 or 448 and portion of each bolster cushion pillow 424 in its pocket 422. This not only helps locate and lock each bolster cushion pillow 424 in place in its pocket 422 formed in the cover 416, it also helps support each bolster cushion pillow 424 once center cushion pillow 428 is inserted and the cover flap 432 zipped up. Once the center cushion pillow 428 is inserted into its pocket 426 and the cover flap 432 zipped up, the center cushion pillow 428 not only defines the center cushion 414 it also helps define the base 402 of the bed 400.

Each pillow 424 and 428 has an outer pillow cover 456 formed of polyester, e.g., 100% polyester, with polyester fiber fill, e.g., 100% polyester fiber fill, within the pillow cover 456 and can be advantageously overfilled to provide better cushioning support to the bed 400. If desired, a polyurethane fill can also be used. Bottom piece of fabric 418 is also made of polyester, e.g., 100% polyester, so that friction is minimized between each pillow 424 and 428 and the corresponding portion of the cover 416 contacting the pillow 424 and 428 when the pet jumps onto the bed 400, claws the bed 400, bites the bed 400 and otherwise interacts with the bed 400. Such low friction between each pillow and the bottom piece of fabric 418 not only minimizes pillow wear, it also helps prevent shedding of fiber filling within each pillow 424 and 428 through its pillow cover 456. This also minimizes misalignment of each bolster cushion pillow 424 during insertion into the cover 416 and subsequent interaction of a pet with the bed 400 thereby minimizing the likelihood of any pet interacting with the bed 400 biting any corner of any pillow 424.

The top piece of fabric 420 can also be made of polyester, e.g., 100% polyester, to help minimize friction but has an outer surface 421 formed of fleece, e.g., wool fleece. Such an outer fleece construction provides a thick outer surface that is cat and dog claw resistant increasing pet bed durability. Such a bed assembly construction advantageously permits a cat to knead the bed 400 with its claws without destroying any pillow 424 and 428 as well as preventing shedding of the pillow filling during kneading. To further minimize pet bed movement during use by a pet, part of the bottom surface 404 of the bed 400 can be of non-skid construction 403 such as by being coated with a sticky material, a rubber, an elastomer, an elastomeric material or the like. Such a non-skid construction advantageously prevents the bed 400 from sliding around on the floor.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

1. A pet bed comprising:
a bed cover having multiple outer pockets, each of the multiple outer pockets having a pocket opening that permits access into and out of the respective outer pocket and defined by a plurality of divider walls disposed within the bed cover dividing each one of the multiple outer pockets from one another spacing the multiple outer pockets about a central portion of the bed cover with each one of the multiple outer pockets configured to removably receive an outer pillow therein forming an outer pet bed cushion therewith, and the central portion of the bed cover comprising a central pocket having a central pocket opening that permits access into and out of the central pocket with the central pocket configured to removably receive a center pillow therein forming a central pet bed cushion therewith; and
each outer pillow and the center pillow being washable and removably held in a corresponding one of the outer and central pockets such that each pillow is removable from and replaceable into the respective pocket through the corresponding pocket opening.

2. The pet bed of claim 1 wherein each one of the pillows are machine washable and machine dryable.

3. (canceled)

4. The pet bed of claim 1 wherein each one of the pockets holds a single pillow.

5. (canceled)

6. The pet bed of claim 1 wherein all of the pillows have a common shape.

7. (canceled)

8. (canceled)

9. (canceled)

10. (canceled)

11. The pet bed of claim 1 wherein each one of the pillows further comprises a pillow cover that encloses cushioning material.

12. The pet bed of claim 11 wherein each pillow cover and the bed cover are made from the same material.

13. (canceled)

14. (canceled)

15. (canceled)

16. The pet bed of claim 1 wherein each multiple outer pocket and each outer pillow received in a corresponding one of the multiple outer pockets defines a bolster that extends outwardly and upwardly beyond the central pet bed cushion.

17. (canceled)

18. (canceled)

19. The pet bed of claim 1 wherein a plurality of the multiple outer pockets extend radially outwardly receiving a radially outwardly extending outer pillow in each pocket defining a bolster cushion and wherein the central pocket positions the center pillow so the center pillow underlies each one of the outer pillows defining a corresponding bolster cushion.

20. The pet bed of claim 19 wherein each one of the outer pillows that defines a corresponding bolster cushion is elongate and the center pillow is circular with a portion of the center pillow abutting an adjacent end of each one of the outer pillows that defines a corresponding bolster cushion.

21. A pet bed comprising:
a bed cover with an interior having multiple pockets around a circumference of the bed cover;
a central pocket centrally located in the interior of the bed cover with an opening, the multiple pockets surrounding the central pocket;
a plurality of divider walls symmetrically dividing a perimeter of the bed cover and separating each of the multiple pockets;
a single opening in the bed cover configured to receive pillows for each of the multiple pockets and the central pocket; and
wherein the pillow in the central pocket and the plurality of divider walls prevent pillows in the plurality of pockets from exiting their respective pocket.

22. (canceled)

23. (canceled)

24. (canceled)

25. (canceled)

26. (canceled)

27. (canceled)

28. (canceled)

29. (canceled)

30. The pet bed of claim 21 wherein each one of the pillows in each of the multiple pockets define upwardly extending bolster cushions defining a plurality of bolsters that extend about a periphery or circumference of the pillow received in the central pocket.

31. The pet bed of claim 30 wherein the pillow received in the central pocket prevents removal of the pillows in each one of the multiple pockets.

32. The pet bed of claim 31 wherein the bed cover has a bottom and defines a closure that exposes the center pocket when opened permitting insertion or removal of the pillow received in the center pocket.

33. The pet bed of claim 31 wherein the bed cover has a bottom and defines a closure that exposes the center pocket when opened permitting insertion or removal of the pillow received in the center pocket before permitting insertion or removal of the pillow in each one of the multiple pockets.

34. The pet bed of claim 21 wherein the perimeter of the bed cover is round and the plurality of dividers each create symmetrical, wedge shaped multiple pockets.

35. The pet bed of claim 34 wherein the pillow in each of the wedge shaped multiple pockets each contact the pillow in the central pocket.

36. The pet bed of claim 35 wherein each of the pillows are machine washable and machine dryable.

37. The pet bed of claim 21 further including a bolster that extends upwardly and at least partially along a perimeter of the pet bed.

38. The pet bed of claim 21 wherein the pillows in the multiple pockets surrounding the central pocket are each of the same shape, and the pillow in the central pocket is a different shape.

39. The pet bed of claim 1 further including:
a single opening extending into an interior of the bed cover configured to receive the outer pillows and the center pillow; and
wherein the plurality of divider walls and the center pillow prevent the outer pillows from exiting their respective pocket.

40. The pet bed of claim 39 wherein each one of the pillows in each of the multiple pockets define upwardly extending bolster cushions defining a plurality of bolsters that extend about a periphery or circumference of the pillow received in the central pocket.

41. The pet bed of claim 40 wherein the pillow received in the central pocket prevents removal of the pillows in each one of the multiple pockets.

42. The pet bed of claim 41 wherein the bed cover has a bottom and defines a closure that exposes the center pocket when opened permitting insertion or removal of the pillow received in the center pocket.

43. The pet bed of claim 41 wherein the bed cover has a bottom and defines a closure that exposes the center pocket when opened permitting insertion or removal of the pillow received in the center pocket before permitting insertion or removal of the pillow in each one of the multiple pockets.
